(19) United States
(12) Patent Application Publication
(10) Pub. No.: US 2005/0011032 A1
(43) Pub. Date: Jan. 20, 2005

(54) Paint roller frame with thumb controlled brake

(76) Inventor: James Thomas Bosler, San Francisco, CA (US)

Correspondence Address: JAMES T. BOSLER, 7 EUGENIA AV, SAN FRANCISCO, CA, 94110-5411, US

(21) Appl. No.: 10/823,892

(22) Filed: Apr. 13, 2004

Related U.S. Application Data
(60) Provisional application No. 60/487,304, filed on Jul. 14, 2003.

(51) Int. Cl. B05C 17/02

(52) U.S. Cl. 15/230.11; 492/13; 492/19

(57) ABSTRACT

A roller style paint applicator that enables the user to halt the free rolling motion of the roller cage by applying thumb pressure to a pushrod assembly (30), pushing its end piece (46) into contact with any household roller brush that has been installed on the cage. Upon cessation of pressure, the brake assembly retracts to its original position, allowing the roller brush to again rotate freely when any force causes it to do so.

### CROSS-REFERENCE TO RELATED APPLICATIONS

PPA 60/487,304 Jul. 14, 2003

### FEDERALLY SPONSORED RESEARCH

Not applicable

### SEQUENCE LISTING OR PROGRAM

Not applicable

### BACKGROUND OF THE INVENTION

1. Field of Invention

This invention relates to a paint roller frame of which the cylindrical brush can be prevented from rolling by means of a thumb-controlled brake.

2. Prior Art

In the science of applying paint and other such liquids to walls and ceilings, the biggest advance in the last century has been the paint roller.

The type most widely used is comprised of a roller frame and a cylindrical roller brush installed upon it. The roller frame is comprised of a handle by which a painter picks it up and uses it, an arm protruding from the end of the handle, and a free-spinning cylindrical cage attached to the other end of the arm, perpendicular to the handle. It is upon that cage that the roller brush is fitted.

One uses the paint roller with a paint tray which is usually separately purchased. The painter picks up the paint roller and then dips the roller brush into the paint in the paint tray. Then s/he works the roller brush upon the ribbed ramp that is standard in paint trays, making it roll thereon in order to better distribute the paint on the roller. Sometimes it is necessary to repeat this process one or two more times in order to thoroughly saturate the roller brush. Then the painter lifts the paint roller out of the paint tray and proceeds to the surface to be painted, typically a wall or ceiling.

The painter rolls the roller brush upon the painting surface, thereby coating the surface with paint. There the advantages of a paint roller are most evident, for it applies paint more quickly and evenly than a brush or pad, and provides more accuracy than a spray applicator.

Among its disadvantages though is that it tends to drip paint when carried between the paint tray and the painting surface. That is because gravity makes the part of the brush with the most paint on it swing down to be on the bottom and drip. This is most relevant when it comes to ceilings: by the time surface contact is made, most of the paint has swung down to be on the bottom. Then as the painter starts rolling, centrifugal force contributes to the dripping. Either the drips fall on the painter, which is unpleasant, or on the floor in the painter's immediate vicinity. Even if a protective floor covering has been laid down, the painter is then likely to step in those drippings and track them elsewhere.

A drip guard can all but eliminate errant drips, but at additional cost. It also requires more effort because of its additional weight on the roller frame, and because its dimensions can be cumbrous.

Errant drips might also be reduced by using a thicker pile brush, though it would spatter more paint during rolling. This phenomenon is addressed by U.S. Pat. No. 5,742,970 to Zurawin (1998) which incorporates a spatter guard, but that shares the same drawbacks as a drip guard.

Instead one might simply choose to transport less paint on the roller. That however would require more trips to the paint tray per gallon of paint, which would substantially add to the painting time.

Another disadvantage of paint rollers is that when a painter dips a roller brush into a paint tray, it then is difficult to get it coated on both sides. Paint trays generally are not deep enough to allow the full immersion of the roller brush. If one fills the paint level too high then it floods the ribbed ramp, making it more difficult to roll the brush without causing waves and spillage.

It is more difficult to get a partially immersed roller brush to roll on a paint tray ramp, for it tends to just slide along painty-side down. Sitting in its own paint, it lacks the traction needed to get it to spin. And when one lifts it out and attempts to set it back down at a different angle, the weight of the side already coated makes it spin down to the bottom before it can be done.

U.S. Pat. No. 5,303,446 to Maresh (1994) discloses a gear driven roller frame in which one manipulates a small lever while dipping, causing the roller brush to rotate in the paint. But for its complex construction and additional weight, it does not resolve the other disadvantages of a paint roller.

Thus the standard paint roller could be improved by making it so that it would
1. speed up the dipping process at the paint tray,
2. reduce the number of trips to the paint tray, and
3. reduce dripping between the paint tray and the surface being painted.

### OBJECTS AND ADVANTAGES

Accordingly, besides the objects and advantages of the prior art described above, the present invention enables the painter to brake the free rolling motion of the roller brush, a feature that improves the prior art in all three ways enumerated above.

The invention speeds up the dipping process by forgoing the ramp traction problem. Applying the thumb-controlled pushrod brake after dipping enables one to coat the top of the roller brush quicker by horizontally inverting the paint roller with a turn of the wrist and then dipping the other side. With the weight of the paint more equilaterally distributed upon the brush, it is much easier to get it rolling on a paint tray ramp.

The invention reduces the number of trips to the paint tray by carrying more paint to the painting surface. Rolling out of paint onto the ramp, the painter can then push the brake when more paint is on the top part of the roller brush. That way a lot more paint can be brought to the wall without dripping. For ceilings, one would apply the brake when more paint is on the far side of the brush, the side that will first make contact with the ceiling. While continuing to apply the brake, one can then spread the paint on the ceiling so that it does not drip down, then release the brake and begin rolling it out.

The invention reduces dripping between the paint tray and the surface being painted by making it so there is less on the bottom of the brush, where it is likely to drip. A concerned painter simply needs to push the brake and then scrape the bottom of the brush against the paint tray ramp to remove any excess. Sometimes a painter will notice a spot across the room that was missed, but had removed the protective floor covering from that area. With this invention a lot more paint can be carried to that spot with confidence that none will drip.

### SUMMARY

In accordance with the present invention, a paint roller frame includes a thumb-controlled pushrod brake assembly for impeding the free rotation of the roller cage. The arm of the roller frame is shaped so that the paint roller cage is close to the handle. The thumb button of the brake is located along the length of the frame handle so as a painter can comfortably push it while grasping the handle with either hand in a handshake manner. The brake assembly has a brush-protecting end piece, internally threaded to allow the removal and disassembly of the brake assembly for cleaning.

### DRAWING—FIGURES

FIG. 1 is a perspective view illustrating the preferred embodiment roller frame, upon which is installed a conventional cylindrical roller brush;

FIG. 2 is an enlarged perspective view of the thumb-controlled brake assembly;

FIG. 3 is a side view of the handle portion of the second embodiment roller frame; and

FIG. 4 is a side view of the handle area of the third embodiment roller frame.

### DRAWINGS—REFERENCE NUMERALS

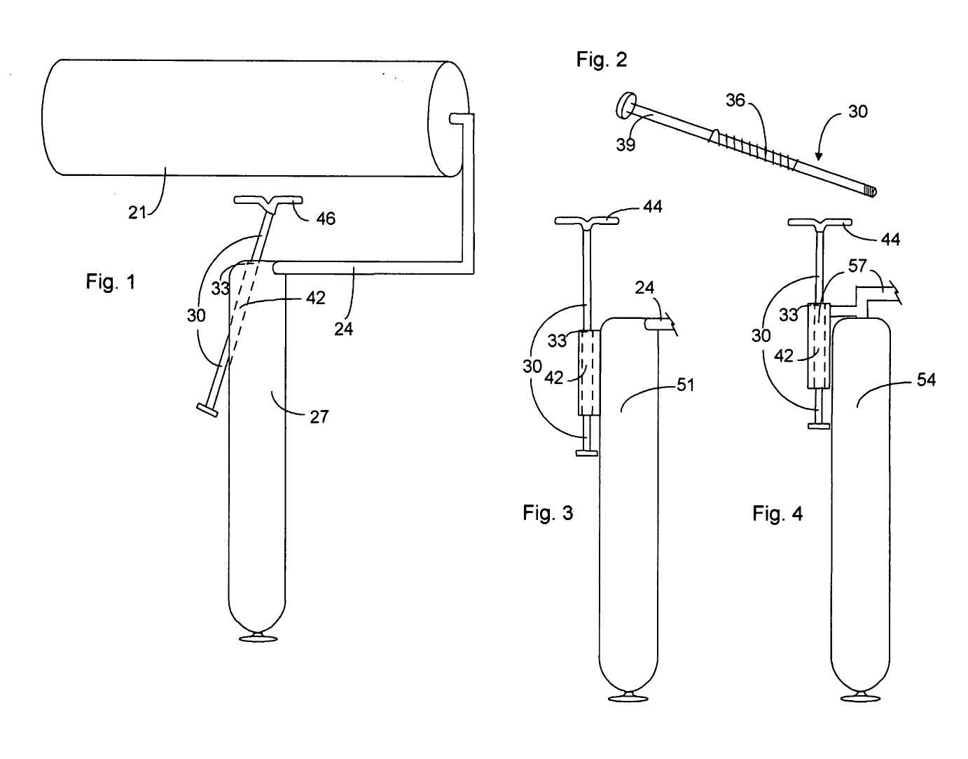

21 conventional cylindrical roller brush
24 right-angled roller frame arm
27 roller frame handle with tunnel accommodating brake assembly
30 thumb-controlled pushrod brake assembly
33 spring retention seating
36 compressible spring
39 pushrod with spring retaining protrusion
42 pushrod tunnel
44 internally threaded end piece
46 internally threaded angled end piece
51 roller frame handle with protruding housing for accommodating brake assembly
54 roller frame handle
57 right-angled roller frame arm with attached tube for accommodating brake assembly
   Preferred Embodiment—FIGS. 1 & 2—Detailed Description

A preferred embodiment of the paint roller frame is illustrated in FIG. 1. A handle 27 features a tunnel 42 that accommodates a brake assembly 30. The tunnel passes through the handle at an angle approximating between ten and thirty degrees.

Referring now to FIG. 2, one end of a compressible spring 36 is affixed to a pushrod 39 by overlapping and exerting tension upon a slight protrusion on its shaft.

Referring again to FIG. 1, the other end of the compressible spring snaps into the spring retention seating 33 when firm pressure is applied to the thumb button during assembly, thereby stabilizing the brake assembly 30 from sliding loosely or rotating within the handle tunnel 42. Then attached to the threaded end of the pushrod is an internally threaded angled end piece 46.

A roller frame arm 24 is fashioned so as to locate any conventional roller brush 21 perpendicularly between two and ten centimeters of the end of the handle.

Preferred Embodiment—FIGS. 1 & 2—Operation

The manner of using the present invention is similar to that of a conventional paint roller, though the painter can elect to operate its thumb-controlled brake 30 to his or her advantage. Thumb pressure pushes it toward the roller brush 21, making the end piece 46 make contact with the roller brush in order to impede its free rotation without causing significant wear. Upon cessation of thumb pressure, a spring 36 retracts the brake to its original position, allowing the roller brush to again rotate freely when any force causes it to do so.

A painter grasps the handle 27 with the preferred hand in a comfortable handshake manner, with the thumb near the thumb button at the end of the brake assembly 30. The painter then dips the roller brush 21 into the paint, and then attempts to roll it on the ramp of a paint tray in order to better distribute the paint upon it. If this is not successful because the slipperiness of the paint causes poor traction, then the painter pushes the pushrod 30 toward the roller brush again to brake it from rolling. The painter can then coat more of the brush by dipping it at different angles, and even after horizontally inverting the roller frame with a turn of the wrist.

The painter would proceed to the painting surface once the roller is adequately saturated. If that surface is a wall, the painter first pushes the pushrod 30 again to brake the roller, scrapes off excess dripping paint from the brush by rubbing it on the paint tray ramp, and then proceeds to the wall. Once the roller comes in contact with the wall, the painter releases the thumb button to unbrake the roller, and then rolls the roller up the wall to distribute the paint.

After the first few trips, the roller brush becomes saturated enough to hold more paint without dripping. At that point the painter can bring still more to the wall by rolling the saturated brush partly into the paint and then rolling it out just a few inches, positioning most of the additional paint collected on the top of the brush. Then the painter again pushes the thumb button to brake the roller, proceeds to the wall, and then rolls the roller up the wall.

If the painting surface is a ceiling, the painter rolls off any excess paint onto the paint tray ramp. Then s/he rolls the roller brush partly into the paint and then rolls it out just a few inches, positioning the additional paint collected on the far side of the brush so it will make it to the ceiling without dripping. Then the painter again pushes the thumb button to brake the roller, and proceeds to the ceiling. Once the roller comes in contact with the ceiling, the painter lightly scrapes it on the ceiling to distribute the paint so that it does not drip. Then s/he releases the thumb brake and rolls over the paint to uniformly distribute it.

The brake assembly 30 and its housing can be cleaned without disassembly either by running water on that portion of the roller frame, or by soaking in a solvent appropriate to paint or other coating medium. The brake assembly can be removed for more thorough cleaning by first unscrewing the end piece 46 and then pulling gently on the thumb button until the spring unseats from its retention seating 33.

Perhaps most styles of roller frame handles are designed with an indentation or other feature that is intended to snag the rim of the paint tray if the roller begins to roll down the ramp and into the paint. That is necessary because the arms of most styles of paint rollers are so long that they require their handles to be placed against or on the rim; otherwise the leverage of the handle on the end of the long arm can tilt it downward and make the paint roller fall out of the tray. Such a feature is not necessary on the present invention however, because of its shorter arm. The handle being made of a lightweight material as paint roller handles typically are these days, that leverage is reduced. Thus placing the far end of the handle against the tray rim is adequate to prevent the roller from rolling into the paint or tilting out of the tray.

Preferred Embodiment—FIGS. 1 & 2—Advantages

A number of advantages of this paint roller frame are evident:
(a) It is easier to saturate a new roller brush by braking its rotation and dipping into the paint tray at different angles without the heavier, paint-laden side swinging to the bottom each time.
(b) Less accidental drippage occurs by braking the roller to prevent its more paint-laden side from swinging to the bottom.
(c) One is able to carry more paint to the painting surface by braking the roller when there is more paint on top, resulting in more surface coverage per trip to the paint tray.
(d) When painting a ceiling as directed, the more paint-laden side of the roller is first to make contact with surface, thus reducing drippage caused by the combination of gravity and the centrifugal force of the roller's rotation upon the surface.
(e) Its arm is fashioned so that the roller brush is closer to the handle. That way the brake assembly does not have to be unstably long in order to reach the roller brush. It thus does not require the addition of any additional frame support, is less likely to bend under use, and more consistently travels along the plane axially common to the roller brush.
(f) The arm being fashioned so that the roller brush is closer to the handle reduces the effects of weight and leverage, reducing the possibility of the paint roller falling out of the paint tray.
   FIGS. 3 & 4—Additional Embodiments

An additional embodiment is shown in FIG. 3. A feature of this roller frame handle 51 is a protruding housing which accommodates the brake assembly 30.

Another embodiment is shown in FIG. 4, in which a housing tube for accommodating the brake assembly 30 is affixed to the paint roller arm 57 at the time of its manufacture.

Both of these embodiments have an internally threaded end piece 44 designed so as to make full parallel contact with the roller brush.

Additional Embodiments—FIGS. 3 & 4—Operation

The operations of additional embodiments FIGS. 3 and 4 are the same as that stated above for the preferred embodiment.

Additional Embodiments—FIGS. 3 & 4—Advantages

These additional embodiments have all the advantages of the preferred embodiment. Also, their differences could mean differing manufacturing processes that might reduce their cost to manufacture. They also have differences in design that could be preferred by certain consumers. Both place less stress upon the pushrod 39 shaft by perpendicularly encountering the roller brush, and so would be more durable when used with a thicker coating medium. FIG. 4 shows a metallic tube for accommodating the brake assembly, which could be advantageous when working with caustic mediums. They are however not the preferred embodiment for normal painting uses. The evident reason is because the angling of its brake assembly 30 relative to the handle 27 lends to the more natural movement of the thumb in pushing the thumb button. That is better for both comfort and to prevent repetitive stress disorder.

Although the descriptions of these embodiments contain many specifics, they should not be construed as limiting the scope of the invention but as merely providing illustrations of some of the presently preferred embodiments of this invention. For example, the threaded end pieces 46, 44 could be wider; not necessary to further reduce wear on the roller, but perhaps preferred by some in order to achieve a more uniform coating of paint. Or, the end piece might merely be an end knob or even absent from the invention if marketed for painters using disposable paint rollers. Another example is that the roller frame handle might be fashioned for a better grip. Thus the scope of the invention should be determined by the appended claims and their legal equivalents, rather than by the examples given.

1. An improved paint roller comprising:
a pushrod whose end is located near the roller handle, positioned for use by the thumb of either hand grasping the handle, and whose other end is near the roller cage so that when said pushrod is pushed it impedes the free rotation of any household roller brush installed on the cage;
a pushrod tunnel which accommodates said pushrod, and
a compressible spring around said pushrod, with one end secured to said pushrod and the other end secured to the end of said pushrod tunnel.

2. The paint roller of claim 1, wherein the roller cage is located between two and ten centimeters of the end of the handle.

3. The paint roller of claim 2, wherein said pushrod tunnel is positioned lengthwise on the rotational plane of said roller cage at an angle relative to the handle of approximately ten to thirty degrees.

4. The paint roller of claim 3, wherein said pushrod tunnel passes through the handle.

5. The paint roller of claim 2, wherein the end of said pushrod is threaded and accommodates a brush-protecting endpiece.

6. The paint roller of claim 5, wherein said pushrod tunnel passes through the handle.

7. The paint roller of claim 2, wherein said pushrod tunnel is positioned lengthwise on the rotational plane of said roller cage at an angle relative to the handle of approximately ten to thirty degrees, and the end of said pushrod is threaded and accommodates a brush-protecting endpiece.

8. The paint roller of claim 7, wherein said pushrod tunnel passes through the handle.

9. The paint roller of claim 1, wherein said pushrod tunnel is located on the rotational plane of said roller cage at an angle relative to the handle of approximately ten to thirty degrees.

10. The paint roller of claim 9, wherein the end of said pushrod is threaded and accommodates a brush-protecting endpiece.

11. The paint roller of claim 9, wherein said pushrod tunnel passes through the handle.

12. The paint roller of claim 11, wherein the end of said pushrod is threaded and accommodates a brush-protecting endpiece.

13. The paint roller of claim 1, wherein the end of said pushrod is threaded and accommodates a brush-protecting endpiece.
